(19) United States
(12) Patent Application Publication
(10) Pub. No.: US 2025/0076953 A1
(43) Pub. Date: Mar. 6, 2025

(54) PROCESSING METHOD AND FIRST ELECTRONIC DEVICE

(71) Applicant: Lenovo (Beijing) Limited, Beijing (CN)

(72) Inventors: Shuang HAN, Beijing (CN); Jinghao XU, Beijing (CN); Huiru ZHAI, Beijing (CN)

(21) Appl. No.: 18/821,872

(22) Filed: Aug. 30, 2024

(30) Foreign Application Priority Data
Sep. 1, 2023 (CN) 202311125876.4

(51) Int. Cl. G06F 1/28; G06F 1/3206; G06F 1/3234

(52) U.S. Cl. CPC G06F 1/28; G06F 1/3206; G06F 1/3265

(57) ABSTRACT

A processing method includes in response to a first electronic device being in a first status, the first electronic device being in a powered status, a second electronic device being in a powered status, and the first electronic device obtaining and outputting image data output by the second electronic device, and in response to the first electronic device being in a second status, the first electronic device being in an unpowered status, and the second electronic device being in the powered status. The first status and the second status are able to be switched. Power consumption of the first electronic device in the first status is greater than in the second status.

### CROSS-REFERENCE TO RELATED APPLICATION

The present disclosure claims priority to Chinese Patent Application No. 202311125876.4, filed on Sep. 1, 2023, the entire content of which is incorporated herein by reference.

### TECHNICAL FIELD

The present disclosure relates to a processing method and a first electronic device.

### BACKGROUND

Two devices are in communication and cooperate with each other. When another device connected to an electronic device does not know the actual operation status of the electronic device, and another device connected to the electronic device is turned off, the electronic device loses power. Thus, the electronic device has an abnormal problem such as a blue screen when the electronic device is turned on next time.

### SUMMARY

The present disclosure provides a processing method. The method includes in response to a first electronic device being in a first status, the first electronic device being in a powered status, a second electronic device being in a powered status, and the first electronic device obtaining and outputting image data output by the second electronic device, and in response to the first electronic device being in a second status, the first electronic device being in an unpowered status, and the second electronic device being in the powered status. The first status and the second status are able to be switched. Power consumption of the first electronic device in the first status is greater than in the second status.

The present disclosure further provides a first electronic device, including a first interface, a power supply apparatus, a display apparatus, and a processing apparatus. The first interface is connected to a second electronic device. The power supply apparatus is configured to supply power to the first electronic device and supply power to the second electronic device through the first interface. The display apparatus is configured to display image data output by the second electronic device obtained through the first interface. The processing apparatus is configured to, in response to the first electronic device being in a first status, control the power supply apparatus to supply power to the first electronic device to cause the first electronic device to be in a powered status and control the power supply apparatus to supply power to the second electronic device through the first interface to cause the second electronic device to be in the powered status, and in response to the first electronic device being in a second status, control the power supply apparatus to stop supplying power to the first electronic device to cause the first electronic device to be in an unpowered status and controlling the power supply apparatus to supply power to the second electronic device through the first interface to cause the second electronic device to be in the powered status. The first status and the second status are able to be switched. Power consumption of the first electronic device in the first status is greater than in the second status.

### BRIEF DESCRIPTION OF THE DRAWINGS

FIG. 1 illustrates a schematic flowchart of a processing method according to some embodiments of the present disclosure.

FIG. 2 illustrates a schematic diagram of a circuit of a big screen supplying power to OPS according to some embodiments of the present disclosure.

FIG. 3 illustrates a schematic flowchart showing a pin status of OPS according to some embodiments of the present disclosure.

FIG. 4 illustrates a schematic diagram of another circuit of a big screen supplying power to OPS according to some embodiments of the present disclosure.

FIG. 5 illustrates a schematic diagram of another circuit of a big screen supplying power to OPS according to some embodiments of the present disclosure.

FIG. 6 illustrates a schematic diagram of a circuit of another big screen supplying power to OPS according to some embodiments of the present disclosure.

FIG. 7 illustrates a schematic diagram of a hardware entity of a first electronic device according to some embodiments of the present disclosure.

FIG. 8 illustrates a schematic diagram of a hardware entity of an electronic device according to some embodiments of the present disclosure.

### DETAILED DESCRIPTION OF THE EMBODIMENTS

Embodiments of the present disclosure described here are used to explain the present disclosure not to limit the present disclosure.

In the following description, suffixes such as “module,” “member,” or “unit,” which are used to indicate elements, are merely used to facilitate the explanation of the present disclosure and do not have any specific meaning. Therefore, “module,” “member,” or “unit” can be used interchangeably.

An electronic device can be implemented in various forms. For example, the electronic devices of the present disclosure can include a mobile electronic device such as a Personal Digital Assistant (PDA), a navigation apparatus, a wearable device, etc., and a fixed electronic device capable of fingerprint collection, such as a digital TV, a desktop computer, etc.

In the following description, the first electronic device and a second electronic device can be taken as an example for description. Those skilled in the art can understand that, except for elements specifically configured for mobile purposes, the construction of embodiments of the present disclosure can also be applied to fixed types of electronic devices.

Based on this, embodiments of the present disclosure provide a processing method applicable to the first electronic device and the second electronic device. The power can be supplied to the second electronic device through the first electronic device under different statuses, which avoids the blue screen due to power loss when the second electronic device is turned on next time and improves the application stability of the second electronic device. FIG. 1 illustrates a schematic flowchart of a processing method according to some embodiments of the present disclosure. As shown in FIG. 1, the method includes the following processes.

At S101, when the first electronic device is in a first state, the first electronic device is in a state of being provided with power (i.e., a powered state), and the second electronic device is also in a powered state. The first electronic device obtains and outputs image data output by the second electronic device.

The first electronic device can include a corresponding first operating system, and the second electronic device can include a corresponding second operating system. That is, the first electronic device and the second electronic device can have independent data processing and computation capabilities. The first operating system and the second operating system can be the same or different. The first status can indicate that the first electronic device is in a powered-on status. In the first status, the first electronic device can provide a voltage to the second electronic device to cause the second electronic device to operate normally, e.g., 19V. When the first electronic device is in the powered-on status, both the first electronic device and the second electronic device can be powered. The first electronic device can obtain the image data output by the second electronic device and output the image data. The first electronic device can display the image data of the second electronic device on a screen or transmit the output of the second electronic device to another device through data transmission.

At S102, When the first electronic device is in a second status, the first electronic device is in a state of not being supplied with power (i.e., an unpowered state), and the second electronic device is in the powered state. The first status and the second status can be switched, and the power consumption of the first electronic device in the first status is greater than the power consumption of the second electronic device in the second status.

The first electronic device can include the first status and the second status. The power consumption of the first electronic device in the powered-on status can be greater than the power consumption of the first electronic device in the sleep status. The second status can include a sleep status or a shutdown status with lower power consumption than the powered-on status.

The power of the second electronic device can be from the power source of the first electronic device. Thus, in the second status, the power source of the first electronic device may no longer supply power to outside or have small power supply power because the first electronic device does not have power consumption needs or has low power consumption needs. Thus, the second electronic device can be turned off due to abnormal power loss.

In embodiments of the present disclosure, when the first electronic device is in the second status, the first electronic device may not be powered. However, the first electronic device can be controlled to continue to supply power to the second electronic device.

In embodiments of the present disclosure, when the first electronic device is in the first status, the first electronic device and the second electronic device can be in the powered status. When the first electronic device is in the second status, the first electronic device can be in the unpowered status, and the second electronic device can be in the powered status. Thus, when the first electronic device is turned off or in a sleep mode, the first electronic device can continue to supply power to the second electronic device to ensure that the second electronic device is continuously powered, which avoids a blue screen due to power loss when the second electronic device is powered on next time and improves the application stability of the second electronic device.

In some embodiments, controlling the first electronic device to enter the first status by the second electronic device includes obtaining a first control instruction output by the second electronic device and responding to the first control instruction to control the first electronic device to enter the first status.

The first control instruction can be used to control the first electronic device to be powered on. The first control instruction may be automatically generated when the second electronic device is powered on or can be generated through a user operation on the second electronic device. The first electronic device can obtain the first control instruction via an interface or wirelessly. The first electronic device can obtain the first control instruction output by the second electronic device.

The first status can be the powered-on status. After receiving the first control instruction sent by the second electronic device, the first electronic device can enter the powered-on status to enter the first status.

In embodiments of the present disclosure, the first electronic device can be controlled to enter the first status by obtaining the first control instruction output by the second electronic device. Thus, the first electronic device can be controlled to be turned on through the second electronic device to enhance the controllability and the operability for the first electronic device.

In some embodiments, controlling the first electronic device to enter the second status via the control instruction and further control the second electronic device to enter the fourth status includes obtaining a second control instruction and responding to the second control instruction to output a third control instruction to the second electronic device. The second control instruction is used to control the first electronic device to switch from the first status to the second status. The third control instruction is used to control the second electronic device to switch from a third status to a fourth status. The power consumption of the second electronic device in the third status is higher than the power consumption of the second electronic device in the fourth status.

The second control instruction can be used to instruct the first electronic device to enter the shutdown status or sleep status. The second control instruction can be output by the second electronic device or obtained by performing an operation on the first electronic device, e.g., pressing a shutdown button, controlling the system to shut down or sleep via a mouse, or wirelessly controlling the first electronic device to shut down or sleep. After receiving the second control instruction, the first electronic device can be controlled to switch from the powered-on status to the sleep status or the shutdown status.

For example, the second electronic device can include 6 operation statuses including S0, S1, S2, S3, S4, and S5. The third status can correspond to any one of S0 to S3. When the power of the second electronic device is cut off in the third status, a turn-on blue screen can be caused. The fourth status can correspond to S4 or S5. After the power of the second electronic device is cut off in the fourth status, the normal use of the device may not be affected by turning on the device again. Thus, the blue screen may not appear. The power consumption of S4 and S5 can be lower than the power consumption of any one of S0 to S3, and the power consumption of S4 can be higher than the power consumption of S5.

In Status S0, all functions of the second electronic device can operate normally, the second electronic device can be in the power-on status, and the power consumption can be highest. In Status S1, other members can operate normally except when the CPU is turned off through a CPU clock controller. That is, the system can be in a low power supply state. The settings of the operating system or the boot system can be configured to turn off screen signal output, stop the hard drive from entering a standby status, and make the power supply indicator blink. When the mouse is moved or any key is pressed, the computer can be woken up. In Status S2, all data currently in the memory of the operating system can be preserved without change, and the device can enter a “soft off” status. Then, except for the memory that needs power to maintain the data, power can be stopped from being supplied to other devices and apparatuses. In Status S3, all data currently in the memory of the operating system can be preserved without change, and the device can enter a “soft off” status. Then, except for the memory that needs power to maintain the data, power can be stopped from being supplied to other devices and apparatuses. In Status S4, all data of the operating system currently in the memory can be stored in the hard drive. When the device is powered on, the data can be directly read into the memory from the hard drive storing the data without running the application again. In Status S5, all devices including the power source can be turned off and in the powered-off status, the power consumption can be 0. Thus, the third control instruction can be used to indicate that the second electronic device starts powering off or enters Status S4. The first electronic device can start powering off after obtaining the second control instruction and generate and send the third control instruction simultaneously to the second electronic device. The second electronic device can receive the third control instruction to enter Status S4 or power-off status from the third status.

In some embodiments, the third control instruction can be used to control the second electronic device to switch from the current status to another status with lower power consumption. For example, the second electronic device can be switched from S0 to any of S1 to S5, from S1 to any of S2 through S5, from S2 to any of S3 through S5, from S3 to S4 or S5, or from S4 to S5.

In embodiments of the present disclosure, the first electronic device can receive the second control instruction. The first electronic device can be controlled to switch from the first status to the second status and output the third control instruction to the second electronic device. The second electronic device can be controlled to switch from the third status to the fourth status. Thus, when the first electronic device is powered off, the second electronic device can be simultaneously controlled to enter the fourth status through the instruction, which avoids the blue screen when the second electronic device is powered on next time to ensure the normal application of the second electronic device and improves the application stability of the second electronic device.

In some embodiments, the first electronic device obtaining the status information of the second electronic device can include the following processes.

First, an indication signal is obtained. The indication signal is used to indicate the status of the second electronic device.

The indication signal can be used to indicate that the second electronic device is in any one of the power-on status, the sleep status, or the hibernation status. The first electronic device can obtain the indication signal corresponding to the second electronic device. The status of the second electronic device can be determined according to the indication signal.

Second, when the indication signal indicates that the second electronic device is in the third status, the second electronic device is in the powered state.

When the indication signal indicates that the second electronic device is in the third status, the second electronic device can be in any status of S0 to S3. Then, the first electronic device can supply power to the second electronic device to prevent the second electronic device from losing power in the third status.

Third, when the indication signal indicates that the second electronic device is in the fourth status, the second electronic device is in the unpowered status. The power consumption of the second electronic device in the third status is higher than in the fourth status.

When the indication signal indicates that the second electronic device is in the fourth status, the second electronic device can be in a status of S4 or S5. Thus, when the second electronic device loses power, the blue screen may not be caused when the second electronic device is powered on again. Therefore, the power can be stopped from being supplied to the second electronic device to cause the second electronic device to be in the power-off status.

In some embodiments, the indication signal can include a plurality of sub-signals. Each sub-signal can be used to indicate the status of the second electronic device.

The indication signal can include at least four sub-signals. A first sub-signal can be used to indicate that the second electronic device is in the powered-on status, corresponding to S0. A second sub-signal can be used to indicate that the second electronic device is in the hibernation status, corresponding to any status of S1 to S4. A third sub-signal can be used to indicate that the second electronic device is in the sleep status, corresponding to S4. A fourth sub-signal can be used to indicate that the second electronic device is in the powered-off status, corresponding to S5. The fourth status can include the sleep status, the hibernation status, and the powered-off stats. Through the plurality of sub-signals, the first electronic device can accurately obtain the actual operation status of the second electronic device.

In some embodiments, by obtaining the indication signal, the first electronic device can supply power to the second electronic device when the indication signal indicates that the second electronic device is in the third status. When the indication signal indicates that the second electronic device is in the fourth status, the first electronic device can stop supplying power to the second electronic device. Thus, the first electronic device can accurately obtain the operation status of the second electronic device, supply power to the second electronic device according to the status of the second electronic device, and reduce the resource loss. Meanwhile, the turn-on blue screen due to the power loss of the second electronic device in the third status can be avoided, and the application stability of the second electronic device can be improved.

In some embodiments, the first electronic device can supply power to the second electronic device through a plurality of power supply paths under different statuses.

First, when the first electronic device is in the first status, the second electronic device can be in the powered status through the first power supply path. When the first electronic device is in the second status, the second electronic device can be in the powered status through the second power supply path. The second power supply path can be different from the first power supply path.

Two ends of the first power supply path can be connected to the power source and the interface of the first electronic device, respectively. The first power supply path can receive the voltage output by the power source of the first electronic device and output the voltage through the interface to supply power to the second electronic device. The second power supply path and the first power supply path can be two different power supply paths. Two ends of the second power supply path can be connected to the power source and the interface of the first electronic device, respectively. When the first electronic device is in the first status, the power can be supplied to the second electronic device through the first power supply path. When the first electronic device is in the second status, the power can be supplied to the second electronic device through the second power supply path.

In some embodiments, the second power supply path can be obtained by modifying the motherboard circuit of the first electronic device. The second power supply path can connect the circuits of the power supply, motherboard, and adapter board of the first electronic device. The second power supply path can include a voltage increase circuit, which can be configured to guide a 5VSB voltage of the motherboard to the adapter board. The voltage can be increased to 19VSB through the voltage increase circuit. Thus, the operation voltage can be provided to the second electronic device.

In some embodiments, the second power supply path can be obtained by adding a circuit in the first electronic device. The second power supply path can connect the circuits of the power source and the adapter board of the first electronic device. The power source can add a 19VSB output through the second power supply path to provide the operation voltage to the second electronic device.

For example, the operation voltage required by the second electronic device can be 19V. The parameters of the electrical signal can be adjusted and set according to the actual parameters of the powered device (the second electronic device).

Second, when the first electronic device is in the first status, the second electronic device can be caused to be in the powered status through the third power supply path. When the first electronic device is in the second status, the second electronic device can be caused to be in the powered status through the third power supply path.

Two ends of the third power supply path can be connected to the power source and the interface of the first electronic device, respectively. The third power supply path can receive the voltage output by the power source of the first electronic device and output the voltage through the interface to supply power to the second electronic device. When the first electronic device is in the first status and the second status, the power can be supplied to the second electronic device through the third power supply path.

In embodiments of the present disclosure, when the first electronic device is in the first status, the second electronic device can be caused in the powered status through the first power supply path. When the first electronic device is in the second status, the second electronic device can be caused to be in the powered status through the second power supply path. In some other embodiments, when the first electronic device is in the first status or the second status, the third power supply path can be used to supply power to the second electronic device. The second electronic device can remain powered through a plurality of different power supply paths to ensure the second electronic device without power loss and avoid the blue screen due to power loss. Thus, the application stability of the second electronic device can be improved.

In some embodiments, determining, by the first electronic device, the status of the first electronic device according to whether the image data of the second electronic device is obtained can include obtaining and outputting the image data when the first electronic device is in the first status and controlling the first electronic device to switch to the second status when the first electronic device does not obtain the image data.

The image data can be the image data of the second electronic device, which can be the image data currently displayed by the second electronic device, or the image data not displayed by the second electronic device but sent to the first electronic device and required the first electronic device to display. The first electronic device can obtain the image data of the second electronic device in the first status and display the image data on the first electronic device or output the image data to another device. When the first electronic device displays the image data, some images of the image data can be selectively displayed according to the image data content or user setting. When the first electronic device does not obtain the image data, the first electronic device can switch from the first status to the second status.

In some embodiments, the first electronic device can obtain and output the image data of the second electronic device while in the first status. When the electronic device does not obtain the image data, the first electronic device can be switched to the second status. Thus, whether the first electronic device needs to be powered off can be determined according to whether the second electronic device transmits the image data to the first electronic device. When no image data needs to be transmitted, the first electronic device can be controlled to enter a power-saving status to save the resource loss of the first electronic device.

The application of the processing method of embodiments of the present disclosure in a practical scene is described below. For example, a large screen system and an open pluggable specification (OPS) computer can be taken as an example for description. The large screen system can correspond to the first electronic device, and the OPS can correspond to the second electronic device.

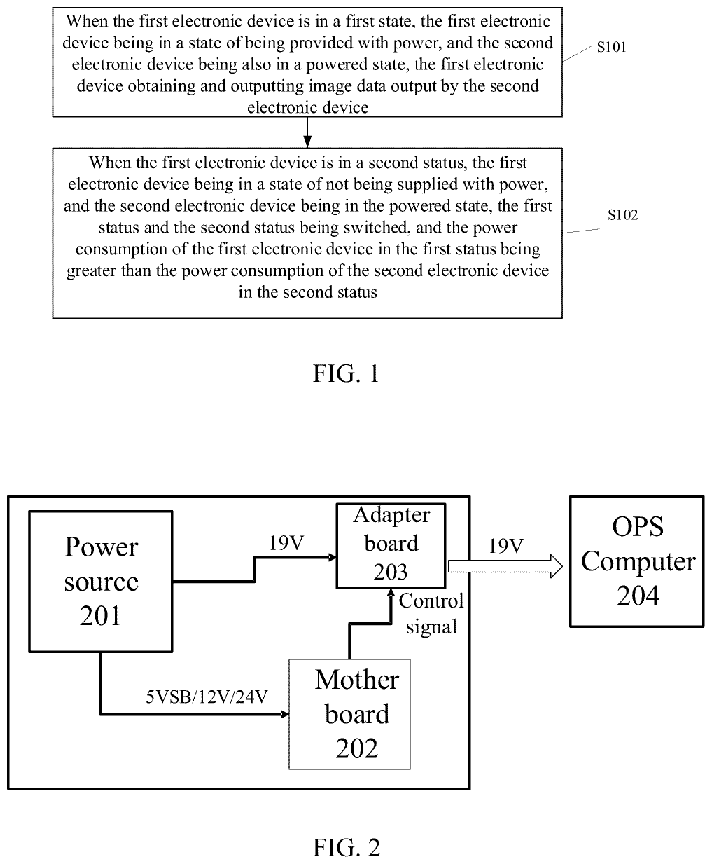

FIG. 2 illustrates a schematic diagram of a circuit of a big screen supplying power to OPS according to some embodiments of the present disclosure. As shown in FIG. 2, a power source 201, a motherboard 202, an adapter board 203, and an OPS computer 204 are provided. When the large screen is powered off, the power source 201 only provides 5VSB to the motherboard 202, and other paths have zero voltage. After the large screen is powered off, the power source 201 stops all paths from outputting normal voltages. When the OPS computer 204 needs to be powered on, the motherboard can issue a power supply instruction to transfer the 19V power of the adapter board 203 to the OPS computer 204 and then issue the OPS powering off instruction. When the OPS computer 204 needs to be powered off, the motherboard 202 can first issue the powering off instruction and then notify the adapter board 203 to turn off the power source 201 after the OPS is powered off. Then, the motherboard 202 can notify the power source 201 to turn off all the power sources and only preserve 5VSB that is uncontrollable.

When the OPS computer is automatically powered off after the large screen is turned off, if the user sets the power button in the Windows power source management to have a sleep or hibernation function, not power off, after receiving the powering off instruction, the OPS computer can enter the hibernation or sleep mode. Then, power loss of the system can follow. When the OPS computer is turned on next time, the OPS can have a blue screen.

When the large screen is automatically powered off after the OPS computer is turned off, and the user clicks sleep or hibernation in Windows, the OPS computer can enter the hibernation or sleep mode. Since the OPS industry standard only includes a power-on status and a power-off status, a status indication pin of the OPS interface can indicate the power-off status. When the large screen is not able to receive a video signal and after the pin is detected to have changed, the large screen can be started for autonomous powering off. The OPS can have a blue screen when the OPS computer is powered on next time.

Embodiments of the present disclosure provide a solution to modify the OPS industry standard and add Windows status indication pins configured to indicate the hibernation and sleep status. The hardware and the software of the large screen and the OPS computer may need to be modified.

As shown in Table 1, in the original OPS industry standard, only one pin of the OPS standard indicates the status of the host and is not able to distinguish hibernation, sleep, or power-off.

TABLE 1

| OPS Pin | Function | Power-on | Hibernation | Sleep | Power-off |
|---|---|---|---|---|---|
| 74 | OPS Power | High | Low | Low | Low |
| | source status | | | | |

When the OPS is in the power-off, hibernation, or sleep mode, the pin status can remain at a low level. Only when the OPS is powered on, the pin status can be at high level.

As shown in Table 2, in embodiments of the present disclosure, two pins 81 and 82 are added. The status of the host can be indicated by the three pins.

TABLE 2

| OPS Pin | Function | Power-on | Hibernation | Sleep | Power-on |
|---|---|---|---|---|---|
| 74 | Power-off | High | High | High | Low |
| 81 | Hibernation | Low | High | Low | Low |
| 82 | Sleep | Low | Low | High | Low |

When the OPS is in the power-on mode, the statuses of the three pins are high level, low level, and low level. When the OPS is in the hibernation mode, the detection results of the three pins are high level, high level, and low level, respectively. When the OPS is in the sleep mode, the detection results of the three pins are high level, low level, and high level. When the OPS is in the power-off mode, the detection results of the three pins are low level, low level, and low level.

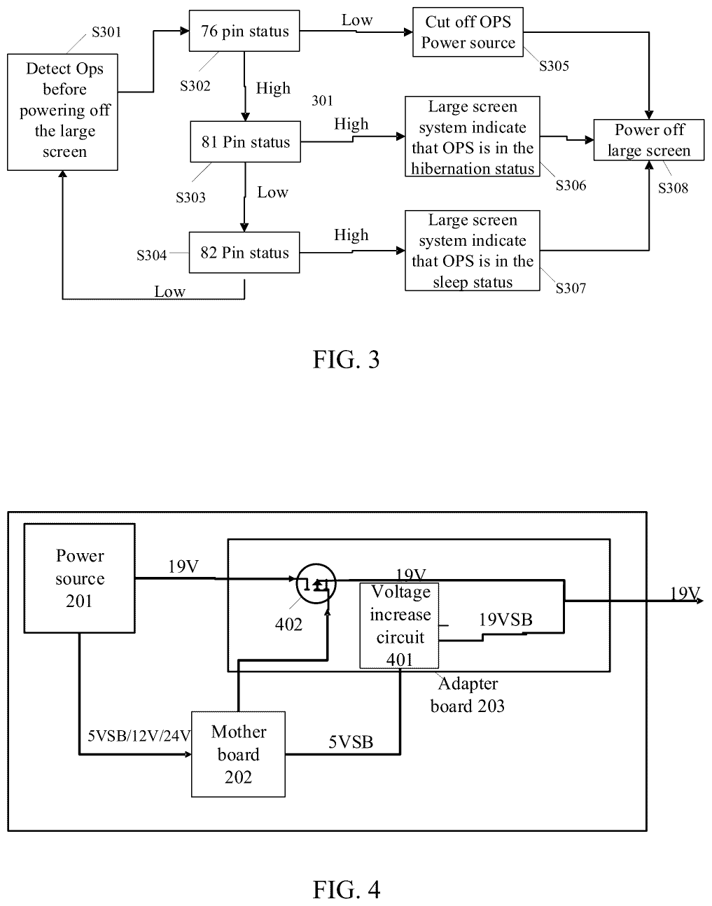

FIG. 3 illustrates a schematic flowchart showing a pin status of OPS according to some embodiments of the present disclosure.

At S301, the OPS is checked before the large screen is powered off.

At S302, the status of pin 76 is checked, S305 is performed when the status of pin 76 is low, and S303 is performed when the status of pin 76 is high.

At S303, the status of pin 81 is checked, S304 is performed when the status of pin 81 is low, and S306 is performed when the status of pin 81 is high.

At S304, the status of pin 82 is checked, S301 is performed when the status of pin 82 is low, and S307 is performed when the status of pin 82 is high.

At S305, the OPS power source is cut off, and S308 is performed.

At S306, the large screen system indicates that the OPS is in the hibernation status, and S308 is performed.

At S307, the large screen system indicates that the OPS is in the sleep mode, and S308 is performed.

At S308, the large screen is powered off.

Embodiments of the present disclosure provide another solution. The OPS and BIOS are modified. When the OPS is in the sleep or hibernation status, the OPS status indication pin can be set to be the same as the power-on status.

Embodiments of the present disclosure provide another solution. 19V can remain to supply power. Thus, the OPS may not lose power in the sleep or hibernation status. Even, in the OPS power-off status, the device can be powered on through the OPS power button. The following three implementations are provided.

First, the power source board is not modified, and 5VSB is increased to 19VSB. As shown in FIG. 4, the power source 201, the motherboard 202, the adapter board 203, and a voltage increase circuit 401 and a switch tube 402 of the adapter board 203. 5VSB/12V/24V voltages output by the power source 201 can be received by the motherboard 202. The motherboard 202 can output a 5VSB voltage to the adapter board 203. The 5VSB voltage can be increased to 19VSB by the voltage increase circuit 401 of the adapter board 203. Meanwhile, the power source 201 can output a 19V voltage to the adapter board 203 through another path. The power source board may not be modified, and the motherboard can be modified. The 5VSB voltage outputted by the power source 201 can be guided to the adapter board 203 from the motherboard 202. The voltage increase circuit 401 can be added to the adapter board 203. The 5VSB voltage can be increased to the 19VSB voltage through the voltage increase circuit 401 to supply power to the OPS computer. Thus, the software of the OPS computer and the large screen may not be modified here.

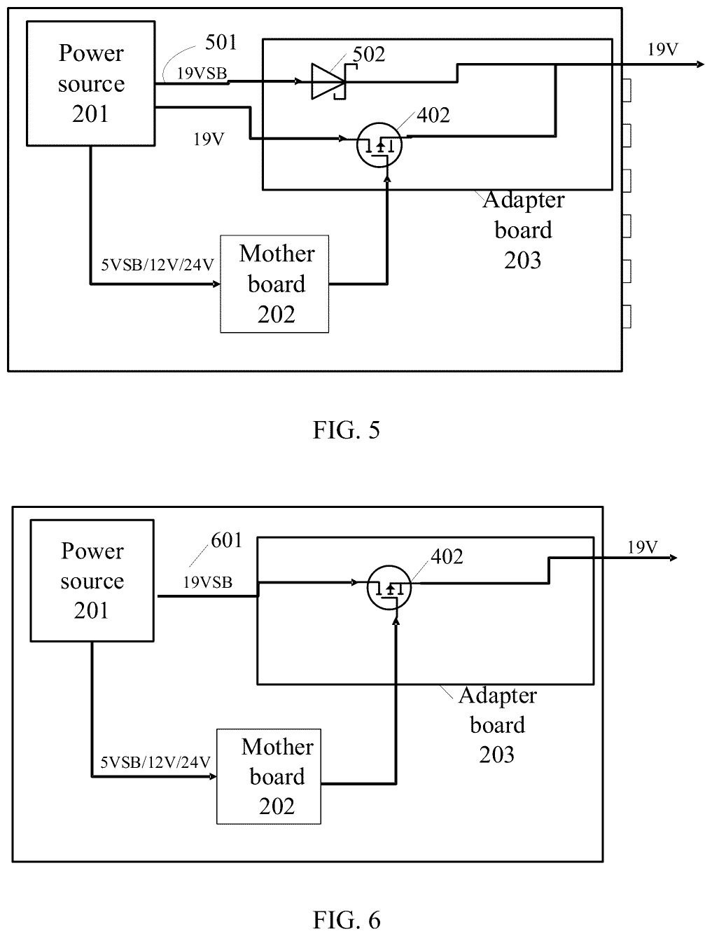

Second, the power source board can be modified to add a 19VSB circuit. As shown in FIG. 5, the power source 201, the motherboard 202, the adapter board 203, and a newly added branch 501 are provided. The adapter board 203 also includes a switch 402 and a Schottky diode 502. The motherboard 202 can receive the 5VSB/12V/24V voltage output by the power source 201 and output the 5VSB voltage to the adapter board 203. The 5VSB voltage can be output by the adapter board 203. Meanwhile, the power source 201 can also output the 19V voltage through the second branch to the adapter board 203. The 19VSB voltage can be output through the newly added branch 501 to the adapter board 203. The newly added branch 501 is a 19VSB voltage output circuit that is newly added to the power source board 201. The power source 201 can output the 19VSB voltage to the adapter board 203. Then, the 19VSB voltage can be output by the adapter board 203 to supply power to the OPS computer. Thus, the large screen software and the OPS software and hardware may not need any modification, and the compatibility may not be impacted.

Third, the power source board is modified to change the original 19V voltage to the 19VSB voltage. As shown in FIG. 6, the power source 201, the motherboard 202, and the adapter board 203 are provided. The power source 201 outputs the 19VSB 601. The adapter board 203 further includes a switch 402. 601 represents the 19VSB voltage changed from the original 19V output by the power source board 201. Thus, the large screen software and the OPS software and hardware may not need any modification, and the compatibility may not be impacted.

In embodiments of the present disclosure, by adding the OPS status indication pin and modifying the setting of the OPS status indication pin, the OPS can remain supplying power at 19V. Thus, the blue screen can be solved when the OPS computer is automatically powered off after the large screen is turned off, and the large screen is automatically powered off after the OPS computer is powered off, which ensures the normal application of the OPS and improves the application stability.

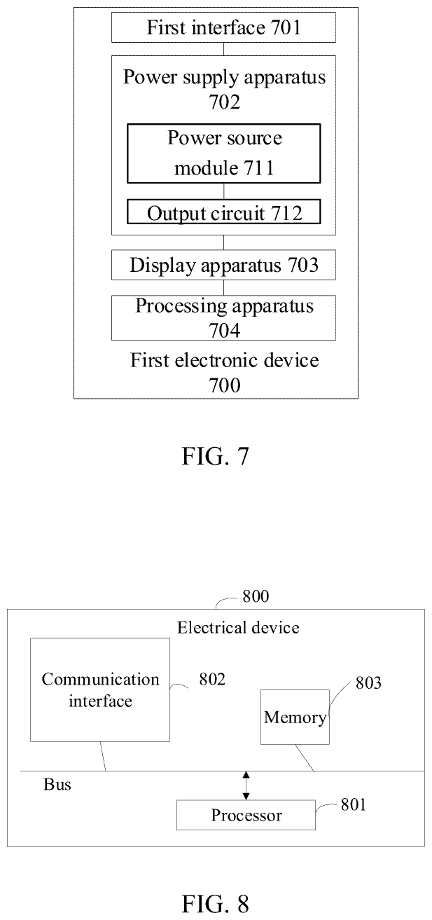

Embodiments of the present disclosure provide a first electronic device 700. As shown in FIG. 7, the first electronic device 700 includes a first interface 701, a power supply apparatus 702, a display apparatus 703, and a processing apparatus 704. The power supply apparatus 702, the display apparatus 703, and the processing apparatus 704 can include various modules and units included in the modules, which can be implemented by a processor of a terminal or a logic circuit. During implementation, the processor can include a CPU, a microprocessor, a digital signal processor, or a field programmable gate array.

The first interface 701 can be connected to a second electronic device.

The power supply apparatus 702 can be configured to supply power to the first electronic device and supply power to the second electronic device through the first interface 701.

The display apparatus 703 can be configured to display image data output by the second electronic device that is obtained through the first interface 701.

The processing apparatus 704 can be configured to control the power supply apparatus 702 to supply power to the first electronic device 700 when the first electronic device 700 is in the first status to cause the first electronic device 700 to be in the powered status to control the power supply apparatus to supply power to the second electronic device through the first interface 701 to cause the second electronic device to be in the powered status, and control the power supply apparatus 702 to stop supplying power to the first electronic device 700 when the first electronic device 700 is in the second status to cause the first electronic device 700 to be in the unpowered status to control the power supply apparatus 702 to supply power to the second electronic device through the first interface 701 to cause the second electronic device to be in the powered status. The first status and the second status can be switched, and the power consumption of the first electronic device 700 in the first status can be larger than the power consumption of the first electronic device 700 in the second status.

In some embodiments, the processing apparatus 704 can be further configured to obtain the first control instruction output by the second electronic device and respond to the first control instruction to control the first electronic device 700 to enter the first status.

In some embodiments, the processing apparatus 704 can be further configured to obtain the second control instruction, the second control instruction being used to control the first electronic device 700 to switch from the first status to the second status, and respond to the second control instruction to output the third control instruction to the second electronic device. The third control instruction can be used to control the second electronic device to switch from the third status to the fourth status. The power consumption of the second electronic device in the third status can be higher than the power consumption of the second electronic device in the fourth status.

The processing apparatus 704 can be further configured to obtain an indication signal. The indication signal can be used to indicate the status of the second electronic device. When the indication signal indicates that the second electronic device is in the third status, the second electronic device can be in the powered status. When the indication signal indicates that the second electronic device is in the fourth status, the second electronic device can be in the unpowered status. The second electronic device can have different power consumption in the third status and the fifth status. The power consumption of the second electronic device in the third status and the fifth status can be larger than the power consumption of the second electronic device in the fourth status.

In some embodiments, the processing apparatus 704 can be further configured to cause the second electronic device to be in the powered status through the first power supply path when the first electronic device 700 is in the first status, and cause the second electronic device to be in the powered status through the second power supply path when the first electronic device 700 is in the second status. The second power supply path can be different from the first power supply path.

In some embodiments, the processing apparatus 704 can be further configured to cause the second electronic device to be in the powered status through the third power supply path when the first electronic device 700 is in the first status and cause the second electronic device to be in the powered status through the third power supply path when the first electronic device 700 is in the second status.

In some embodiments, the processing apparatus 704 can be further configured to obtain and output the image data when the first electronic device 700 is in the first status and control the first electronic device 700 to be switched to the second status when the first electronic device 700 does not obtain the image data.

Embodiments of the present disclosure provide the first electronic device, including the first interface connected to the second electronic device, the power supply apparatus supplying power to the first electronic device and supplying power to the second electronic device through the first interface, and the display apparatus displaying the image data output by the second electronic device. Thus, the first electronic device can continue to supply power to the second electronic device, which avoids the blue screen when powering on the second electronic device due to the power loss of the second electronic device when the first electronic device is in the sleep or hibernation status and the first electronic device cannot supply power to the second electronic device. The second electronic device can be continuously supplied with power through the first electronic device, which improves the application stability of the device.

In some embodiments, the power supply apparatus 702 can further include a power source module 711 configured to supply power and an output circuit 712 connected to the first interface 701 and the power supply module 711 to cause the power supply module 711 to supply power to the second electronic device via the output circuit and through the first interface 701.

In some embodiments, the output circuit 712 can include a first circuit and a second circuit connected to the first interface 701. When the first electronic device 700 is in the first status, the power source module 711 can provide an operation voltage to the second electronic device through the first circuit. When the first electronic device 700 is in the second status, the voltage output by the power source module 711 can be converted into the operation voltage through the second circuit and then can be provided to the second electronic device.

In some embodiments, the output circuit 712 can include a third circuit and a fourth circuit connected to the first interface 701. When the first electronic device 700 is in the first status, the power source module 711 can supply the operation voltage to the second electronic device through the fourth circuit. When the first electronic device 700 is in the second status, the power supply module 711 can supply the operation voltage to the second electronic device through the fourth circuit.

In some embodiments, the output circuit 712 can include a fifth circuit connected to the first interface 701. When the first electronic device 700 is in the first status, the power supply module 711 can provide the operation voltage to the second electronic device through the fifth circuit. When the first electronic device 700 is in the second status, the power supply module 711 can supply the operation voltage to the second electronic device through the fifth circuit.

In embodiments of the present disclosure, the second electronic device can be maintained in the powered status through different circuits, which avoids the power on the blue screen due to power loss. Thus, the application stability of the second electronic device can be improved.

In addition, embodiments of the output circuit are merely used to make the present disclosure clearer and do not limit the present disclosure.

In some embodiments, the first electronic device can further include at least two of a first pin, a second pin, and a third pin. The first pin can be configured to detect the status of a fourth pin of the second electronic device. The second pin can be configured to detect the status of a fifth pin of the second electronic device. The third pin can be configured to detect the status of a sixth pin of the second electronic device. The first electronic device can be further configured to obtain the indication signal of indicating the status of the second electronic device according to the detection results of the at least two pins of the first pin, the second pin, and the third pin.

In the present disclosure, the first electronic device can include at least two of the first pin, the second pin, and the third pin. The status of the second electronic device can be determined through the statuses of the at least two pins. For example, the statuses of the fourth pin and the fifth pin of the second electronic device can be detected through the first pin and the second pin. The detection result can include high level and high level, high level and low level, low level and high level, and low level and low level. Each detection result can correspond to the status of the second electronic device. The status of the second electronic device can include a power-on status, a sleep status, a hibernation status, and a power-off status. Similarly, the statuses of the at least two pins of the second electronic device can be detected through the second pin and the third pin, or the statuses of the at least two pins of the second electronic device can be detected through the second pin and the third pin. Thus, the indication signal of indicating the status of the second electronic device can be obtained according to the at least two detection results of the at least two pins of the first electronic device to determine that the second electronic device is in at least one status of the power-on status, the sleep status, the hibernation status, or the power-off status.

In some embodiments, the status of the second electronic device can be determined through three or more pins. For example, the first pin can be configured to detect whether the second electronic device is in the power-on status of the power-off status. The second pin can be configured to detect whether the second electronic device is in the hibernation status. The third pin can be configured to detect whether the second electronic device is in the sleep status. The detection result of the first pin can be low level when the second electronic device is powered off and high level for other situations. The detection result of the second pin can be high level when the second electronic device is in the hibernation sleep and high level for other situations. The detection result of the third pin can be high level when the second electronic device is in the sleep status and low level for other situations. Thus, when the second electronic device is in the power-on status, the detection result of the three pins can include high level, low level, and low level. When the second electronic device is in the hibernation status, the detection result of the three pins can include high level, high level, and low level. When the second electronic device is in the sleep status, the detection status of the three pins can include high level, low level, and high level. When the second electronic device is in the power-off status, the detection result of the three pins can include low level, low level, and low level.

Embodiments of the present disclosure provide the first electronic device, including the at least two pins of the first pin, the second pin, and the third pin, which can be configured to detect the statuses of the fourth pin, the fifth pin, and the sixth pin of the second electronic device, obtain the indication signal of the status of the second electronic device according to the detection result of the at least two pins to determine the status of the second electronic device. Thus, the indication pin configured to detect the status of the second electronic device can be added to differentiate the sleep status and the hibernation status of the second electronic device from the power-off status, which prevents the second electronic device from being detected as the second electronic device is in the power-off status in the sleep status or the hibernation status. Therefore, the accuracy of detecting the second electronic device can be improved.

In embodiments of the present disclosure, if the above method is realized by the software functional modules and sold or applied as an individual product, the above method can be stored in a terminal-readable storage medium. Based on this understanding, an essence or a part contributing to the present disclosure of the technical solution of embodiments of the present disclosure can be implemented by a software product. The terminal software product can be stored in the storage medium including instructions to cause the terminal (e.g., a computer or server) to perform all or a part of the method of embodiments of the present disclosure.

FIG. 8 illustrates a schematic diagram of a hardware entity of an electronic device according to some embodiments of the present disclosure. The electronic device 800 can be the first electronic device or the second electronic device. As shown in FIG. 8, the electronic device 800 includes a processor 801, a communication interface 802, and a memory 803. The processor 801 can generally control the overall operation of the electronic device 800. The communication interface 802 can enable the terminal to communicate with other terminals or servers through a network. The memory 803 can be used to store instructions and applications executable by the processor 801 and cache the data (e.g., image data, audio data, voice communication data, and video communication data), which can be implemented by a FLASH or a random access memory (RAM).

Correspondingly, embodiments of the present disclosure provide a storage medium storing an executable instruction that, when executed by the processor, causes the processor to perform the above method.

The description of the storage medium and the device embodiments can be similar to the description of the method embodiments and can have similar beneficial effects as the method embodiments. For technical details not disclosed in the storage medium and device embodiments of the present disclosure, reference can be made to the description of the method embodiments of the present disclosure.

In some embodiments of the present disclosure, the device and the method can be implemented by other manners. The device embodiments described above are merely illustrative. For example, the division of the unit can merely be a logical functional division. The unit can be divided in another manner. For example, a plurality of units or assemblies can be combined or integrated into another system, or some features can be ignored or not performed. In addition, the mutual coupling, direct coupling, or communication connection among the displayed or discussed members can be indirect couplings or communication connections through some interfaces, devices, or units, which can be electrical, mechanical, or another manner. The separate member can be or not be physically separated, and the displayed member can be or not be physical units. The members can be at one place or distributed at a plurality of network units. A part or all units can be selected as needed to implement the purpose of the solution of embodiments of the present disclosure.

In addition, functional units of embodiments of the present disclosure can be integrated into one processing unit, or each unit can be an individual unit. In some embodiments, two or more units can be integrated into one unit. The integrated unit can be implemented by hardware or by hardware and software functional unit. Those ordinary skills in the art should understand that all or some steps of the method embodiments can be implemented through the program instructing the related hardware. The program can be stored in the readable storage medium that, when the program is executed, the steps of the method embodiments can be performed. The storage medium can include various media that can store program codes, such as a mobile storage device, read-only memory (ROM), random access memory (RAM), magnetic disks, or optical discs. In some other embodiments, if the integrated units are implemented as software functional modules and sold or applied as independent products, the integrated units can also be stored in the readable storage medium. Based on this understanding, the essence or the part contributing to the existing technology of the technical solutions of the present disclosure can be embodied as a software product. The software product can be stored in a storage medium, including instructions used to cause the terminal to perform the whole or a part of the method of embodiments of the present disclosure. The storage medium can include a medium storing the program codes, such as a mobile storage device, ROM, RAM, magnetic disks, or optical discs. The above are embodiments of the present disclosure. However, the scope of the present disclosure is not limited to this. Those skilled in the art can think of modifications or replacements within the scope of the present disclosure. These modifications and replacements should be within the scope of the present disclosure. Thus, the scope of the present disclosure is subject to the scope of the claims.

What is claimed is:

1. A processing method comprising:
in response to a first electronic device being in a first status, the first electronic device being in a powered status, a second electronic device being in a powered status, and the first electronic device obtaining and outputting image data output by the second electronic device; and
in response to the first electronic device being in a second status, the first electronic device being in an unpowered status, and the second electronic device being in the powered status;
wherein the first status and the second status are able to be switched;
power consumption of the first electronic device in the first status is greater than in the second status.

2. The method according to claim 1, further comprises:
obtaining a first control instruction output by the second electronic device; and
in response to the first control instruction, controlling the first electronic device to enter the first status.

3. The method according to claim 1, further comprising:
obtaining a second control instruction, the second control instruction being used to control the first electronic device to switch from the first status to the second status;
in response to the second control instruction, outputting a third control instruction to the second electronic device, the third control instruction being used to control the second electronic device to switch from a third status to a fourth status, and power consumption of the second electronic device in the third status is higher than in the fourth status.

4. The method according to claim 3, further comprising:
obtaining an indication signal, the indication signal being used to indicate a status of the second electronic device;
in response to the indication signal indicating that the second electronic device is in the third status, the second electronic device being in the powered status; and
in response to the indication signal indicating that the second electronic device is in the fourth status, the second electronic device being in the unpowered status;
wherein the power consumption of the second electronic device in the third status is greater than in the fourth status.

5. The method according to claim 4, wherein the indication signal includes a plurality of sub-signals, each sub-signal indicating a status of the second electronic device.

6. The method according to claim 1, wherein the second electronic device being in the powered status includes:
in response to the first electronic device being in the first status, causing the second electronic device to be in the powered status through a first power supply path; and
in response to the first electronic device being in the second status, causing the second electronic device to be in the powered status through a second power supply path, wherein the second power supply path is different from the first power supply path.

7. The method according to claim 1, wherein the second electronic device being in the powered status includes:
in response to the first electronic device being in the first status, causing the second electronic device to be in the powered status through a third power supply path; and
in response to the first electronic device being in the second status, causing the second electronic device to be in the powered status through the third power supply path.

8. The method according to claim 1, further comprising:
in response to the first electronic device being in the first status, obtaining and outputting the image data; and
in response to the first electronic device not obtaining the image data, controlling the first electronic device to switch to the second status.

9. A first electronic device comprising:
a first interface connected to a second electronic device;
a power supply apparatus configured to supply power to the first electronic device and supply power to the second electronic device through the first interface;
a display apparatus configured to display image data output by the second electronic device obtained through the first interface; and
a processing apparatus configured to:
in response to the first electronic device being in a first status, control the power supply apparatus to supply power to the first electronic device to cause the first electronic device to be in a powered status and controlling the power supply apparatus to supply power to the second electronic device through the first interface to cause the second electronic device to be in the powered status; and
in response to the first electronic device being in a second status, control the power supply apparatus to stop supplying power to the first electronic device to cause the first electronic device to be in an unpowered status and control the power supply apparatus to supply power to the second electronic device through the first interface to cause the second electronic device to be in the powered status;
wherein:
the first status and the second status are able to be switched; and
power consumption of the first electronic device in the first status is greater than in the second status.

10. The first electronic device according to claim 9, further comprising at least two of a first pin, a second pin, and a third pin, wherein:
the first pin configured to detect a status of a fourth pin of the second electronic device;
the second pin configured to detect a status of a fifth pin of the second electronic device;
the third pin configured to detect a status of a sixth pin of the second electronic device; and
the first electronic device is further configured to obtain an indication signal indicating the status of the second electronic device according to a detection result of the at least two of the first pin, the second pin, and the third pin.

11. The first electronic device according to claim 9, wherein the power supply apparatus includes:
a power source module configured to supply power; and
an output circuit connected to the first interface and the power source module to cause the power source module to supply power to the second electronic device via the output circuit through the first interface.

12. The first electronic device according to claim 11, wherein:
in response to the first electronic device being in the first status, the power source module supplies an operation voltage to the second electronic device through a first circuit, and in response to the first electronic device being in the second status, a voltage output by the power source module is converted into the operation voltage through a second circuit, and then the operation voltage is supplied to the second electronic device;
the output circuit includes a third circuit and a fourth circuit connected to the first interface, in response to the first electronic device being in the first status, the power source module supplies the operation voltage to the second electronic device through a third circuit, and in response to the first electronic device being in the second status, the power source module supplied the operation voltage to the second electronic device through a fourth circuit; or
the output circuit includes a fifth circuit connected to the first interface, in response to the first electronic device being in the first status, the power source module supplies the operation voltage to the second electronic device through the fifth circuit, and in response to the first electronic device being in the second status, the power source module supplies the operation voltage to the second electronic device through the fifth circuit.
